(19) United States
(12) Patent Application Publication
(10) Pub. No.: US 2008/0101966 A1
(43) Pub. Date: May 1, 2008

(54) High efficient compact radial blower

(75) Inventors: Edward Lopatinsky, San Diego, CA (US); Lev Fedoseyev, El Cajon, CA (US); Daniel Schaefer, Kanarravile, UT (US)

Correspondence Address: Edward Lopatinsky, SUITE 307, 5450 COMPLEX ST., SAN DIEGO, CA, 92123, US

(73) Assignee: Industrial Design Laboratories Inc.

(21) Appl. No.: 11/904,898

(22) Filed: Sep. 28, 2007

Related U.S. Application Data
(60) Provisional application No. 60/855,068, filed on Oct. 27, 2006.

(51) Int. Cl. H02K 9/06

(52) U.S. Cl. 417/423.4; 417/423.15; 417/423.7; 417/424.1

(57) ABSTRACT

A radial blower comprising an impeller, an electric drive and a housing. The impeller comprises an impeller disk with the first and second sides, radial blades protruded from the first side, a central hub mounting on an axle, and an inflow hub integrated with the impeller disk. The electric drive comprises a magnetized rotor located from the second side of the impeller disk and a stator with a central opening surrounded by circumferentially arrayed flat coil windings. The magnetized rotor comprises spaced apart by an axial gap a flat ferromagnetic ring and a layer of magnetic means. The housing comprises a base, a shaped upper side, and a side part. The shaped upper side at least partially surrounds the magnetized rotor. The stator at the outer is rigidly bounded with the shaped upper side while the inner part of the stator is placed at the axial gap.

### CROSS REFERENCE TO RELATED APPLICATIONS

The present application claims the benefit of priority of U.S. Provisional Patent Application No. 60/855,068 filed Oct. 27, 2006 for Edward Lopatinsky et al. the entire content of which is incorporated herein by reference.

### FIELD OF THE INVENTION

The present invention relates generally to radial type impeller blowers for cooling of electronic devices. More particularly, the present invention relates to relative thin blowers. The present invention is particularly, but not exclusively, useful for cooling systems for regulating the temperature of electronic components of blade servers.

### BACKGROUND OF THE INVENTION

The regulation of the temperature due to heat generated inside the housing of an electronic device is an important consideration during the design of an electronic device. Cooling is important because if left unchecked, heat can cause electronic devices to malfunction during use or lead to premature device failure. As improvements in processor size and speed occur, the amount of heat generated by the larger and faster processors also increases. Additionally, improved processors require larger power supplies and auxiliary components that generate increased amounts of heat and require improved systems for heat removal.

Another factor that aggravates the need for improved heat removal cooling systems is the trend towards making computing devices such as blade server smaller and especially thinner. The trend toward smaller and thinner electronic devices having larger, faster processors renders the traditional heat removal cooling systems inadequate for several reasons.

In order to enhance the cooling capacity of a cooling device, an electrically powered blower is often mounted within or on top of a heatsink of the cooling device. In operation, the blower forces air to pass over fins of the heatsink, thus, cooling the heatsink by enhancing the heat transfer from the fins into the ambient air.

There are known devices of this type, for example, U.S. Pat. No. 6,688,379 “Heat Dissipation Device with High Efficiency”. The device described in this US patent comprises a radial blower that produces a flow passing by heat exchanging channels of the heatsink. The radial blower comprises conventional hub electric drive spaced at a flowing part inside of a radial impeller thus restrains the air flow and therefore decrease the total amount of air passing through the heatsink. By this reason, the thermal efficiency of this heat dissipation device is insufficient.

Due to modern requirements for cooling devices, especially in respect to a combination of the thermal efficiency and an available space, flat electric drives are often used in radial blowers for cooling of electronic components. There are such devices describe in U.S. Pat. No. 6,664,673 “Cooler for Electronic Devices”. This device comprises a flat stator plate made as circuit board and a magnetized rotor fixed to a radial impeller of the blower. The flat stator and the magnetized rotor are located in different parallel planes and separated by an air gap. According to this invention the flat stator is made as the flexible printed circuit board placed at four point supports thus represents an oscillating contour.

However, such arrangement cause a vibration of the flat stator and magnetized rotor due to a rise of oscillation forces in a direction perpendicular to the planes of the flat stator and the magnetized rotor. These forces determine by an interaction between magnetic poles of the stator and rotor. In one's turn the vibration generates an increasing sound level thus contradicts with modern requirements for cooling devices.

On the other hand mentioned vibration causes energy losses thus decrease the motor efficiency of the electric drive and, correspondingly, blower efficiency.

There are another heat-dissipating devices described in U.S. Pat. No. 6,700,781 “Heat-Dissipating Module for Removing Heat Generated from Heat-Generating Device” comprises a flat stator plate made as circuit board and a magnetized rotor fixed to a radial impeller of the blower. The flat stator and the magnetized rotor also located in different parallel planes. The magnetized rotor comprises two magnet portions included magnets thus the flat stator is placed in an air gap between these magnets portions.

However such design requires additional space for placement of mentioned magnets portions.

It would be desirable to provide high efficient compact radial blower for cooling device that would overcome these problems associated with required space, increased sound level and decreased blower efficiency.

### SUMMARY OF THE INVENTION

Accordingly, it is an object of the present invention to provide a high efficient compact radial blower for electronic device, which is capable of significantly improving of blower performances such as smaller dimensions, especially thickness, decreased sound level and increased blower efficiency.

In order to achieve this object, the high efficient compact radial blower comprises an impeller, an electric drive and a housing. The impeller comprises an impeller disk with the first and second sides, radial blades protruded from the first side, a central hub mounting on an axle, and an inflow hub integrated with the impeller disk. The inflow hub rigidly fixed with the central hub by at least 2 brackets, thus forms an impeller inlet. The electric drive comprises a magnetized rotor located from the second side of the impeller disk and a stator with a central opening surrounded by circumferentially arrayed flat coil windings having magnetic axes parallel to the axle. The magnetized rotor comprises spaced apart by an axial gap a flat ferromagnetic ring and a layer of magnetic means. The housing comprises a base supporting said axle, a shaped upper side with a blower inlet, and a side part with a blower outlet. The shaped upper side at least partially surrounds the magnetized rotor. At least one side of the stator at the outer is rigidly bounded with the shaped upper side while the inner part of the stator is placed at the axial gap. The stator when is powered creates electromagnetic field providing a rotation of the impeller, thus ambient air flows through the blower inlet, the impeller inlet, the blades and the blower outlet in a series way.

The flat ring has teeth at the periphery and the layer of magnetic means is integrated with the impeller disk while the flat ring is rigidly bounded with the inflow hub.

The layer of magnetic means comprises circumferentially arrayed permanent magnets having magnetic axes parallel to the axle and the permanent magnets are flush-mounted on the second side of the impeller disk.

There is another option of the layer of magnetic means when this layer may comprise peripheral teeth-shaped flat ring flush-mounted on the second side of the impeller disk and made from ferromagnetic material, and a permanent ring magnet with magnetic axis parallel to the axle placed coaxially on the peripheral teeth-shaped flat ring.

There is also another variant of mutual arrangement of the flat ring and the layer of magnetic means. Thus, the flat ring is integrated with the impeller disk while the layer of magnetic means is rigidly bounded with the inflow hub. In this case the layer of magnetic means comprises circumferentially arrayed permanent magnets having magnetic axes parallel to the axle and fixed to a disk rigidly bounded with the inflow hub.

The stator may be made as a printed circuit board.

The side part has a spiral shape in the axial view, thus the side part together with the base and the shaped upper part form a spiral blower casing.

There is another option of the housing when the side part comprises of at least three hollow standoffs rigidly connected with the base and the shaped upper side by push pin connectors are placed inside of each hollow standoff, thus the outer borders of the shaped upper side and the base together with the hollow standoffs form the blower outlet.

For both design options of the housing the base may be made of high heat conductive material further comprises pin-fin structure surrounded by the impeller, thus the radial blower serves as a heat-dissipating device.

There is also another variant of mutual arrangement of the electric drive and the impeller in respect to the housing. According to this second embodiment the impeller comprises an impeller disk with the first and second sides, radial blades protruded from the first side, and a central hub integrated with the impeller disk and mounting on an axle. The electric drive comprises a magnetized rotor located from the second side of the impeller disk and a stator with a central opening surrounded by circumferentially arrayed flat coil windings having magnetic axes parallel to the axle. The magnetized rotor comprises spaced apart by an axial gap a flat ferromagnetic ring and a layer of magnetic means. The housing comprises a base supporting the axle, a shaped upper side with a blower inlet, and a side part with a blower outlet. The shaped upper side at least partially surrounds the magnetized rotor. At least one side of the stator at the outer is rigidly bounded with the base while the inner part of the stator is placed at the axial gap. The stator when is powered creates electromagnetic field providing a rotation of the impeller, thus ambient air flows through the blower inlet, the impeller inlet, the blades and the blower outlet in a series way.

The layer of magnetic means comprise circumferentially arrayed permanent magnets having magnetic axes parallel to the axle and the permanent magnets are flush-mounted in respect to the second side of the impeller disk.

The layer of magnetic means may comprise a peripheral teeth-shaped flat ring flush-mounted in respect to the second side of the impeller disk and made from ferromagnetic material and a permanent ring magnet with magnetic axis parallel to the axle and placed at the central part of the peripheral teeth-shaped flat ring from the side opposite to the impeller disk. The flat ferromagnetic ring may have teeth at the periphery.

According to another design option the flat ferromagnetic ring may be farther incorporated with circumferentially arrayed permanent magnets having magnetic axes parallel to the axle and spaced at the periphery of the flat ring.

The central hub may have an axisymmetric profile in respect to the axle with a generatrix comprises of at least two opposite curved 90 degrees radiuses.

The foregoing and other objectives, features and advantages of the invention will be more readily understood upon consideration of the following detailed description of the invention, taken in conjunction with the accompanying drawings.

### BRIEF DESCRIPTION OF THE DRAWINGS

FIG. 1 is a perspective view showing the first embodiment of the compact radial blower;

FIG. 2 is a cross-section view A-A from FIG. 1 showing the first embodiment of the radial blower;

FIG. 2A is an enlarged view B from FIG. 2;

FIG. 3 is a perspective view showing the first embodiment of the compact radial blower when the shaped upper side and half of the side part not shown;

FIG. 4 is an exploded perspective view of FIG. 3 showing the first embodiment of the compact radial blower when the flat ferromagnetic ring not shown;

FIG. 5 is a perspective view showing the impeller of the compact radial blower according the first embodiment;

FIG. 6 is a perspective view showing the variant of the first embodiment of the compact radial blower with pin-fin structure thus the radial blower serves as a heat-dissipating device (the flat ferromagnetic ring not shown);

FIG. 7 is a perspective view showing the housing of the variant of the first embodiment of the compact radial blower when the base comprises pin-fin structure;

FIG. 8 is a perspective view showing the second variant of the first embodiment of the compact radial blower when the side part comprises four hollow standoffs rigidly connected with the base;

FIG. 9 is an exploded perspective view showing the second variant of the first embodiment of the compact radial blower on FIG. 8;

FIG. 10 is an exploded perspective view showing the electric drive according to the second variant of the first embodiment of the compact radial blower on FIG. 8;

FIG. 11 is a perspective view showing the second embodiment of the compact radial blower;

FIG. 12 is a cross-section view C-C from FIG. 11 showing the second embodiment of the radial blower;

FIG. 12A is an enlarged view D from FIG. 12.

FIG. 13 is a perspective view showing the second embodiment of the compact radial blower when the shaped upper side and half of the side part not shown.

FIG. 14 is an exploded perspective view of FIG. 13 showing the second embodiment of the compact radial blower.

FIG. 15 is an exploded bottom perspective view of FIG. 13.

FIG. 16 is a perspective view showing the impeller of the compact radial blower according the second embodiment.

FIG. 17 is a perspective view showing the second variant of the first embodiment of the compact radial blower when four hollow standoffs comprises clamping claws.

FIG. 18 is an exploded perspective view of FIG. 17.

### DETAILED DESCRIPTION OF PREFERRED EMBODIMENTS

Preferred embodiments of the present invention will be described in detail below with reference to the accompanying drawings.

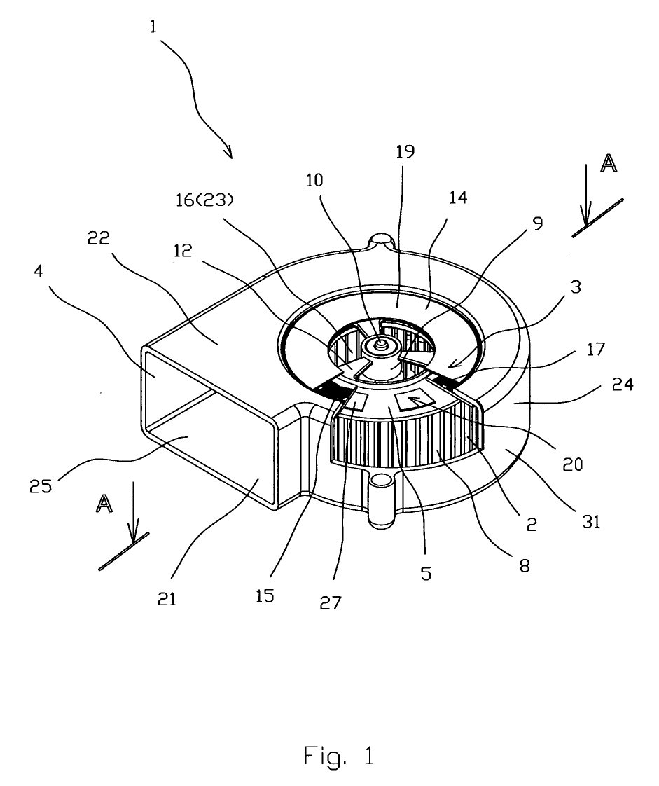

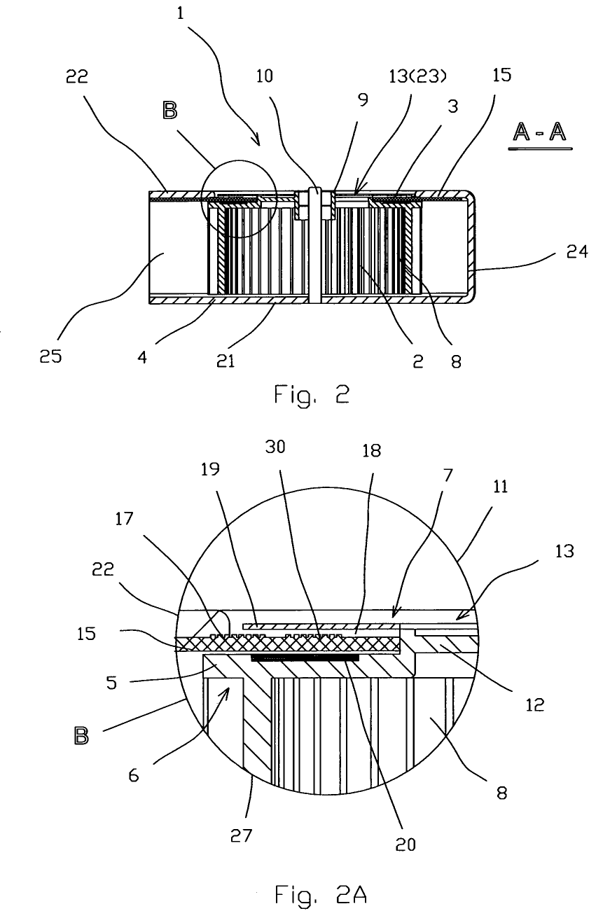

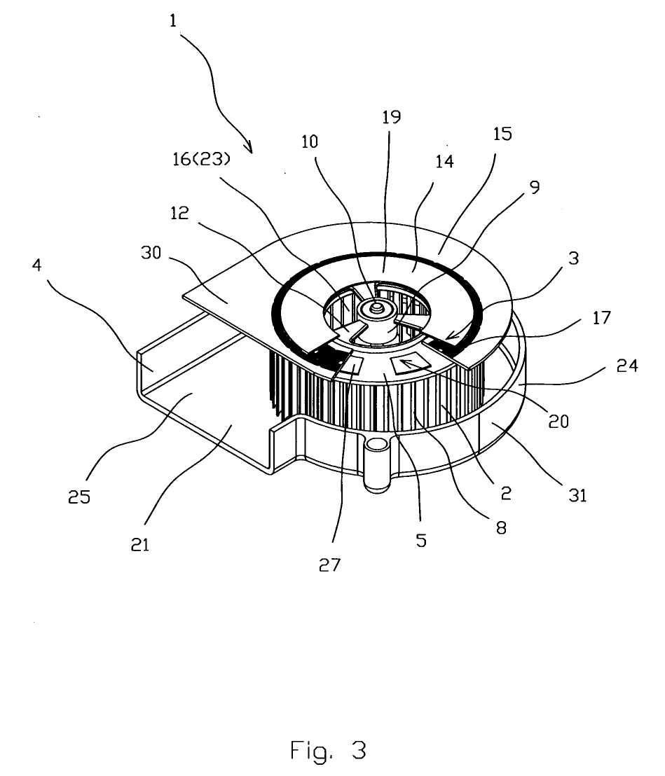

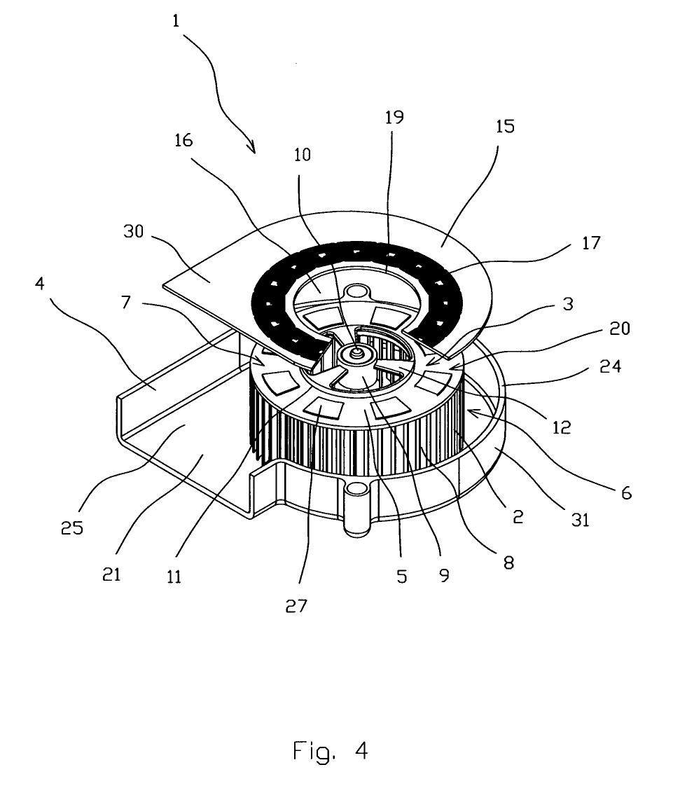

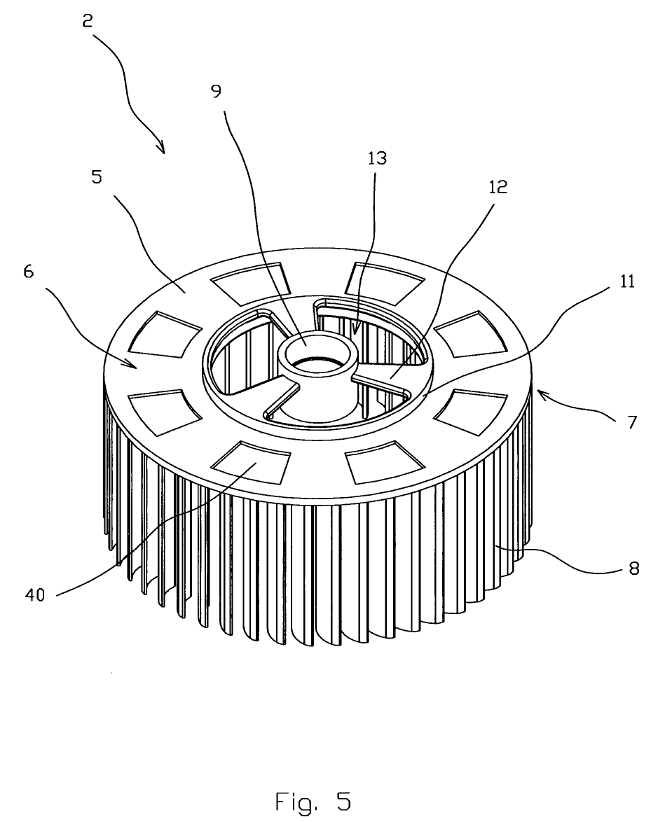

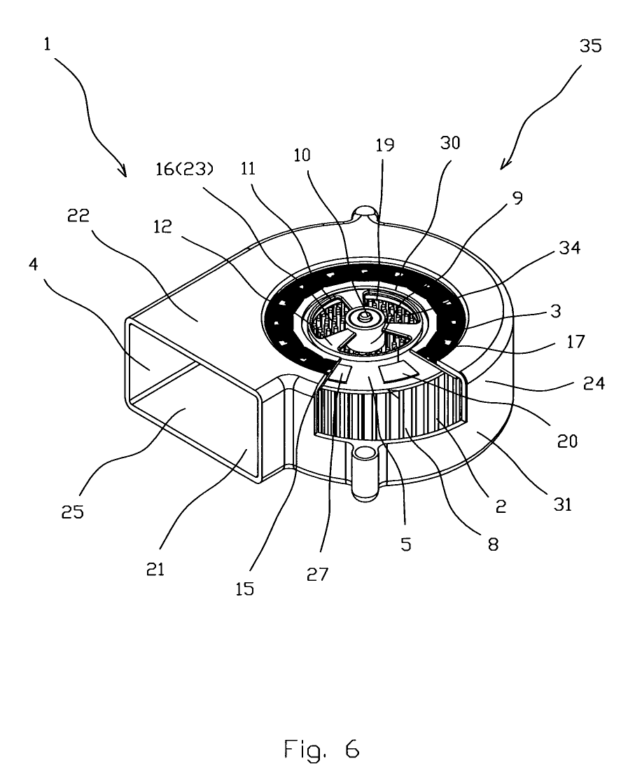

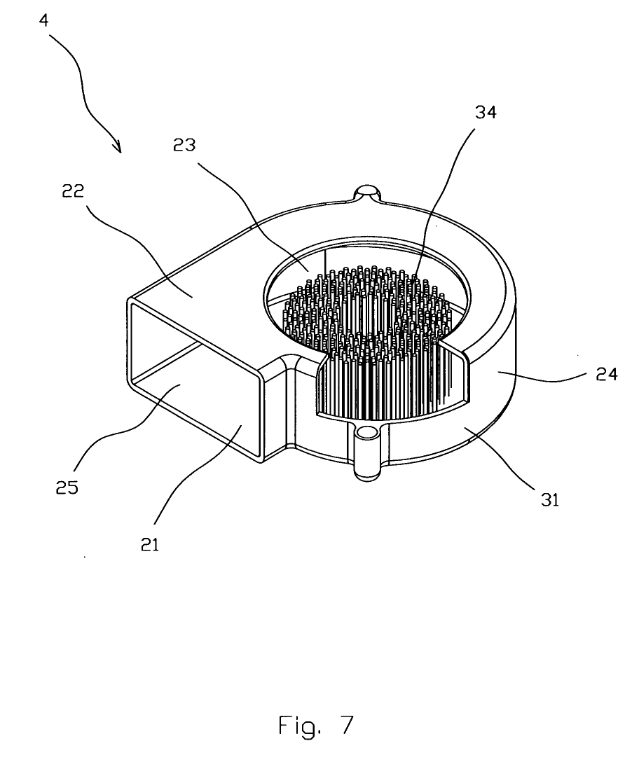

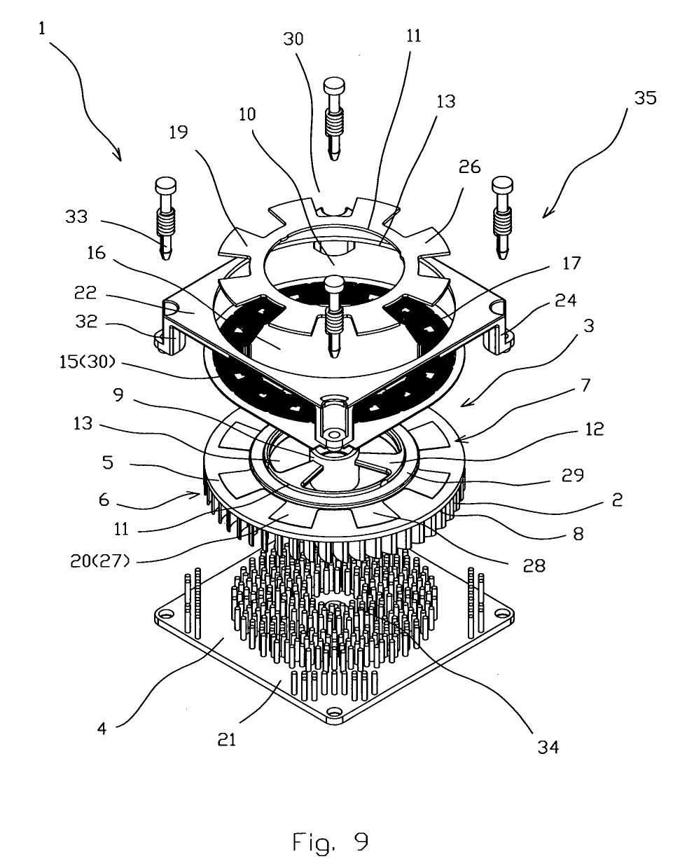

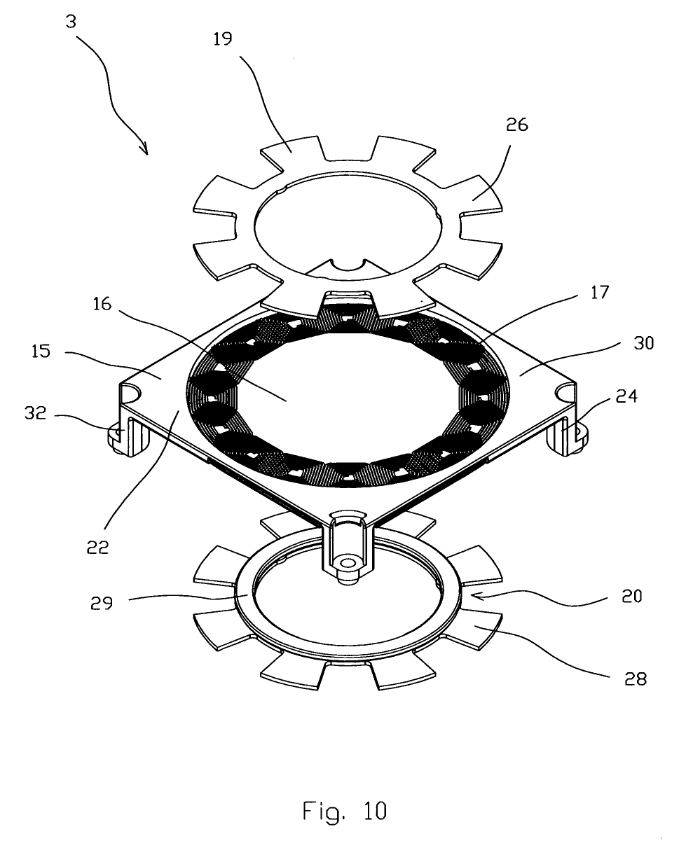

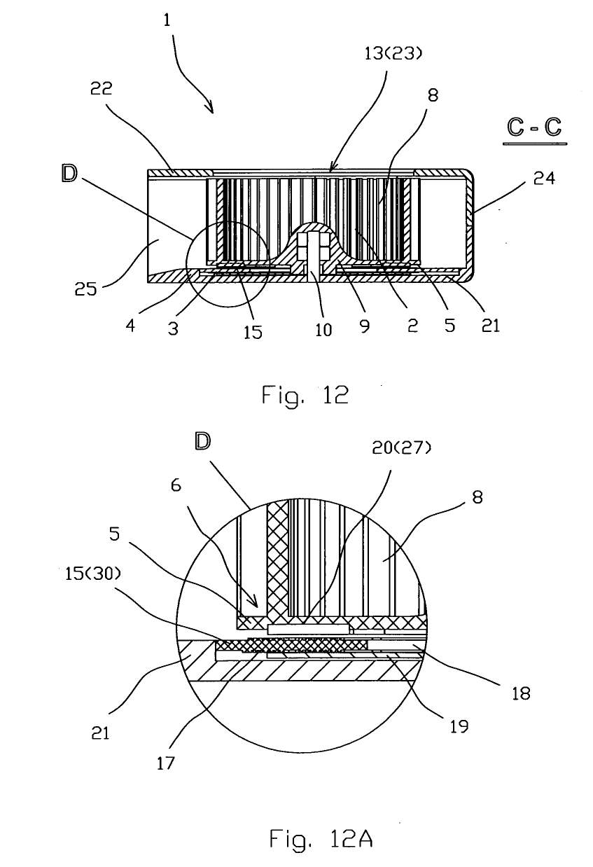

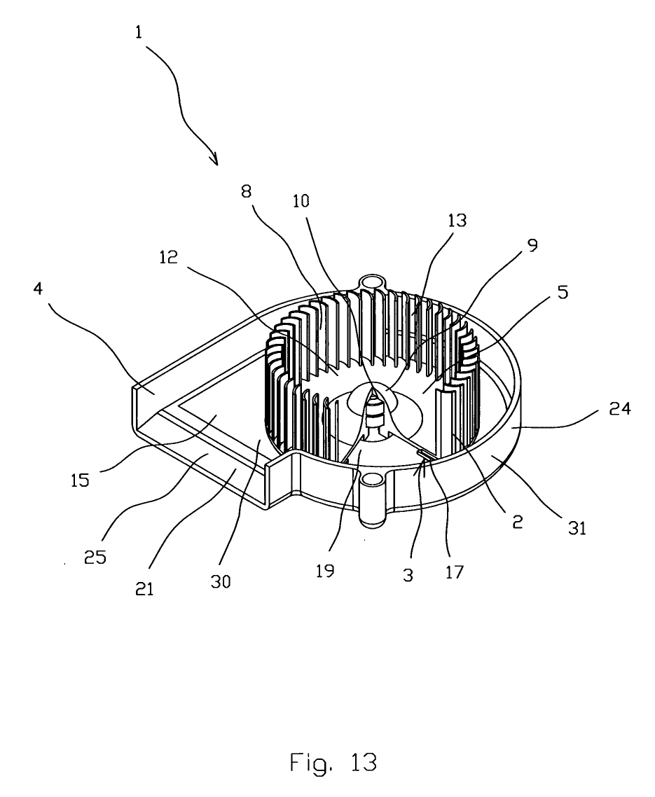

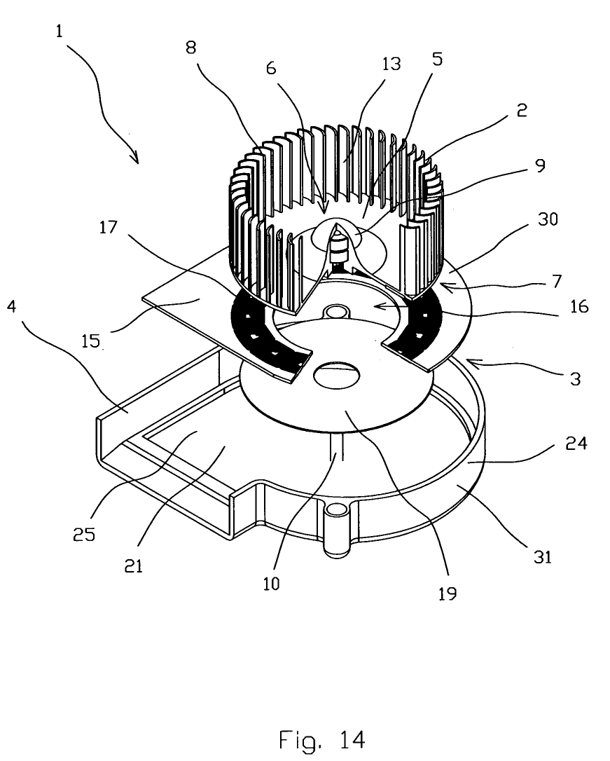

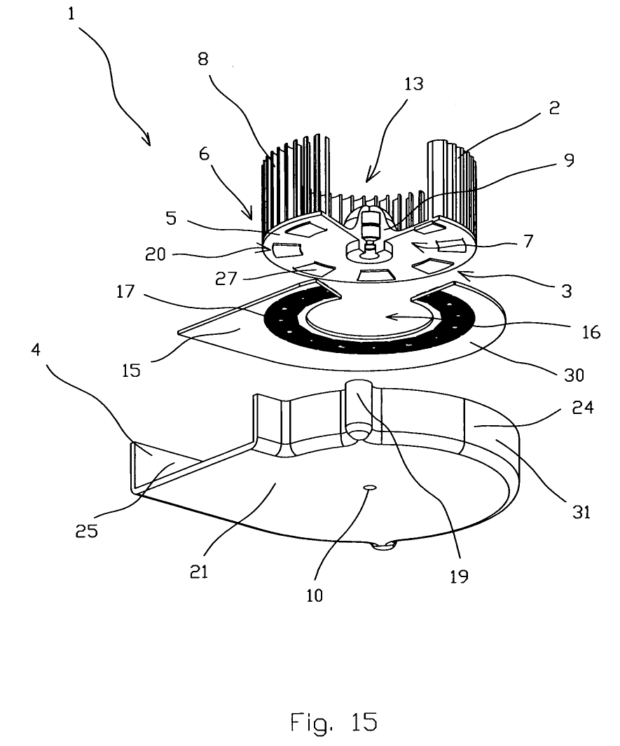

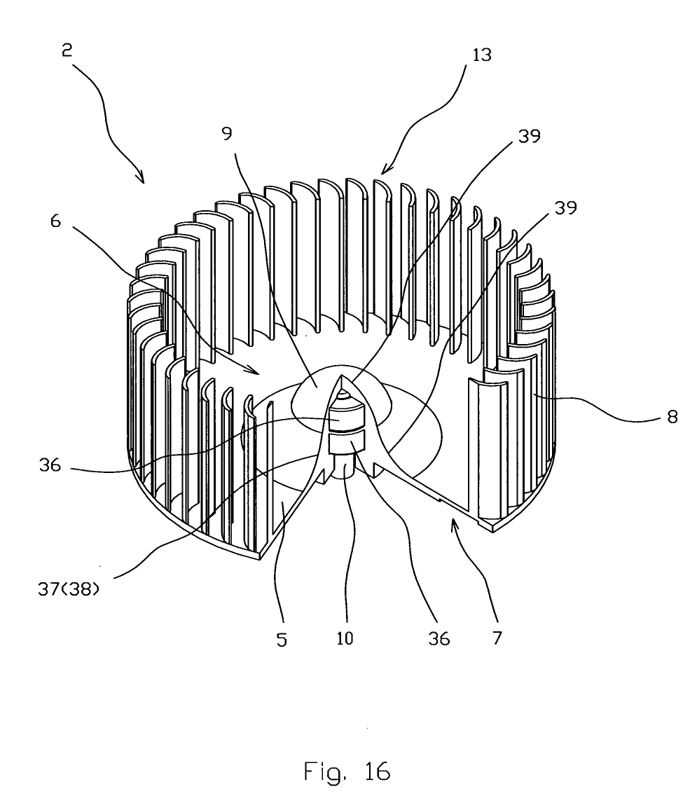

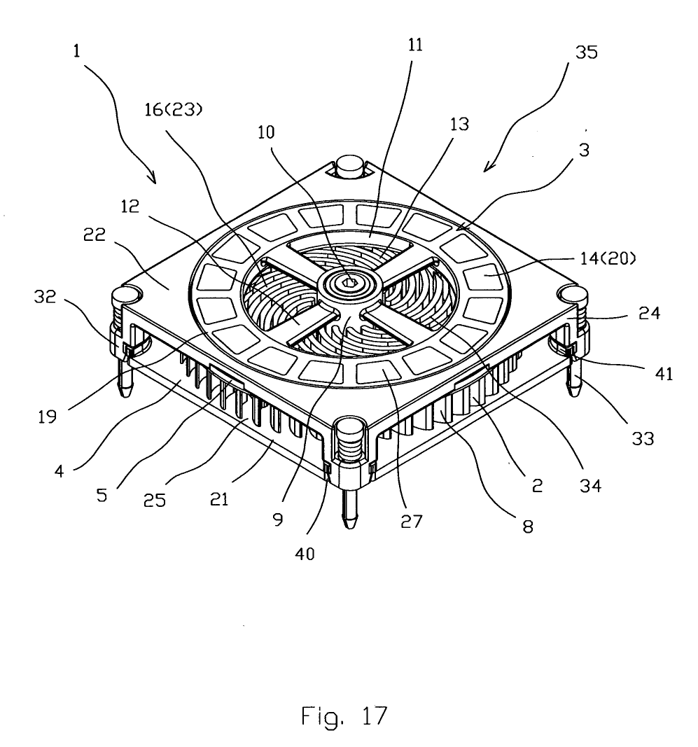

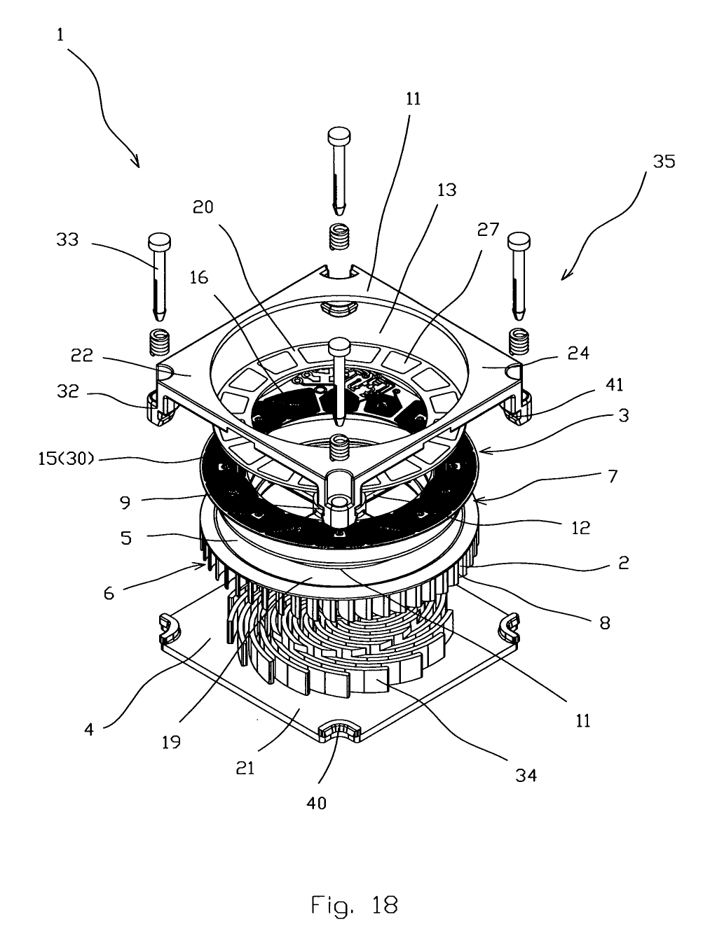

FIGS. 1-18 show embodiments of the present invention.

The high efficient compact radial blower 1 according to the first embodiment (FIGS. 1-10 comprises an impeller 2, an electric drive 3 and a housing 4. The impeller 2 comprises an impeller disk 5 with the first 6 and second 7 sides, radial blades 8 protruded from the first side 6, a central hub 9 mounting on an axle 10, and an inflow hub 11 integrated with the impeller disk 5. The inflow hub 11 rigidly fixed with the central hub 9 by at least 2 brackets 12, thus forms an impeller inlet 13. The electric drive 3 comprises a magnetized rotor 14 located from the second side 7 of the impeller disk 5 and a stator 15 with a central opening 16 surrounded by circumferentially arrayed flat coil windings 17 having magnetic axes parallel to the axle 10. The magnetized rotor 14 comprises spaced apart by an axial gap 18 a flat ferromagnetic ring 19 and a layer of magnetic means 20. The housing 4 comprises a base 21 supporting the axle 10, a shaped upper side 22 with a blower inlet 23, and a side part 24 with a blower outlet 25. The shaped upper side 22 at least partially surrounds the magnetized rotor 14. At least one side of the stator 15 at the outer is rigidly bounded with the shaped upper side 22 while the inner part of the stator 15 is placed at the axial gap 18. The stator 15 when is powered creates electromagnetic field providing a rotation of the impeller 2, thus ambient air flows through the blower inlet 23, the impeller inlet 13, the blades 8 and the blower outlet 25 in a series way.

The flat ring 19 may have teeth 26 at the periphery and the layer of magnetic means 20 is integrated with the impeller disk 5 while the flat ring 19 is rigidly bounded with the inflow hub 11.

The layer of magnetic means 20 comprises circumferentially arrayed permanent magnets 27 having magnetic axes parallel to the axle 10 and the permanent magnets 27 are flush-mounted on the second side 7 of the impeller disk 5.

There is another option of the layer of magnetic means 20 when this layer may comprise peripheral teeth-shaped flat ring 28 flush-mounted on the second side 7 of the impeller disk 5 and made from ferromagnetic material, and a permanent ring magnet 29 with magnetic axis parallel to the axle 10 placed coaxially on the peripheral teeth-shaped flat ring 28.

There is also another variant of mutual arrangement of the flat ring 19 and the layer of magnetic means 20. Thus, the flat ring 19 is integrated with the impeller disk 5 while the layer of magnetic means 20 is rigidly bounded with the inflow hub 11. In this case the layer of magnetic means 20 comprises circumferentially arrayed permanent magnets 27 having magnetic axes parallel to the axle 10 and fixed to the peripheral teeth-shaped flat ring 28 rigidly bounded with the inflow hub 11.

The stator 15 may be made as a printed circuit board 30.

The side part 24 has a spiral shape in the axial view, thus the side part 24 together with the base 21 and the shaped upper part 22 form a spiral blower casing 31.

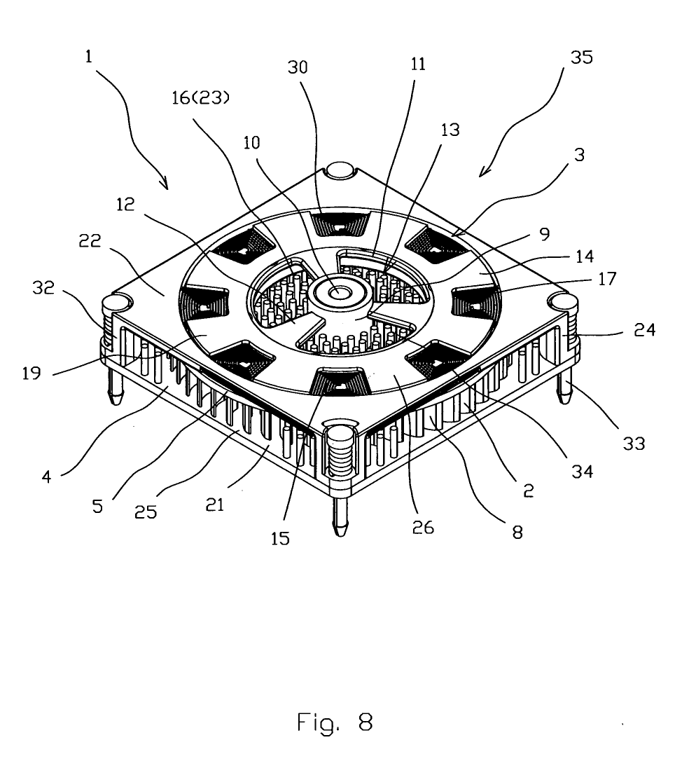

There is another option of the housing 4 (FIGS. 8-10) when the side part 24 comprises of at least three hollow standoffs 32 rigidly connected with the base 21 and the shaped upper side 22 by push pin connectors 33 are placed inside of each hollow standoff 32, thus the outer borders of the shaped upper side 22 and the base 21 together with the hollow standoffs 32 form the blower outlet 25.

The base 21 may comprise clamping lugs 40 located at the corners of the base 21 and hollow standoffs 32 may comprise clamping claws 41, thus the clamping lugs 40 and clamping claws 41 provide together reliable junction between the base 21 and the side part 24.

For both design options of the housing 4 the base 21 may be made of high heat conductive material further comprises pin-fin structure 34 surrounded by the impeller 2, thus the radial blower 1 serves as a heat-dissipating device 35.

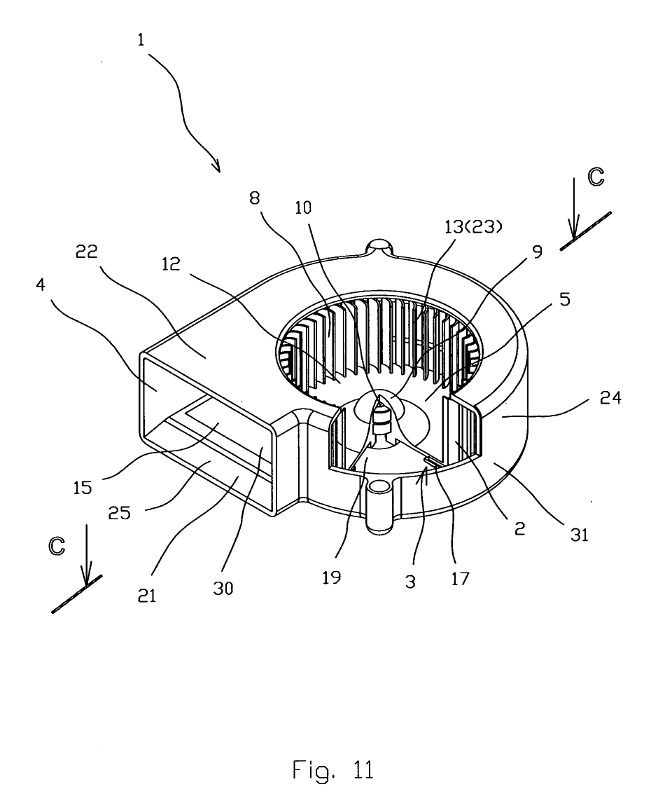

There is also another variant of mutual arrangement of the electric drive 3 and the impeller 2 in respect to the housing 4. According to this second embodiment (FIGS. 11-16) the impeller 2 comprises an impeller disk 5 with the first 6 and second 7 sides, radial blades 8 protruded from the first side 6, and a central hub 9 integrated with the impeller disk 5 and mounting on an axle 10 by bearings 36. The electric drive 3 comprises a magnetized rotor 14 located from the second side 7 of the impeller disk 5 and a stator 15 with a central opening 16 surrounded by circumferentially arrayed flat coil windings 17 having magnetic axes parallel to the axle 10. The magnetized rotor 14 comprises spaced apart by an axial gap 18 a flat ferromagnetic ring 19 and a layer of magnetic means 20. The housing 4 comprises a base 21 supporting the axle 10, a shaped upper side 22 with a blower inlet 23, and a side part 24 with a blower outlet 25. The shaped upper side 22 at least partially surrounds the magnetized rotor 14. At least one side of the stator 15 at the outer is rigidly bounded with the base 21 while the inner part of the stator 15 is placed at the axial gap 18. The stator 15 when is powered creates electromagnetic field providing a rotation of the impeller 2, thus ambient air flows through the blower inlet 23, the impeller inlet 13, the blades 8 and the blower outlet 25 in a series way.

The layer of magnetic means 20 comprises circumferentially arrayed permanent magnets 27 having magnetic axes parallel to the axle 10 and the permanent magnets 27 are flush-mounted in respect to the second side 7 of the impeller disk 5.

The layer of magnetic means 20 may comprise a peripheral teeth-shaped flat ring 28 flush-mounted in respect to the second side 7 of the impeller disk 5 and made from ferromagnetic material and a permanent ring magnet 29 with magnetic axis parallel to the axle 10 and placed at the central part of the peripheral teeth-shaped flat ring 28 from the side opposite to the impeller disk 5. The flat ferromagnetic ring 19 may have teeth 26 at the periphery.

According to another design option the flat ferromagnetic ring 19 may be farther incorporated with circumferentially arrayed permanent magnets 27 having magnetic axes parallel to the axle 10 and spaced at the periphery of the flat ring 19.

The central hub 9 may have an axisymmetric profile 37 in respect to the axle with a generatrix 38 comprises of at least two opposite curved 90 degrees radiuses 39.

According to both embodiments of the high efficient compact radial blower 1 the magnetized rotor 14 comprises spaced apart by an axial gap 18 a flat ferromagnetic ring 19 and a layer of magnetic means 20 thus decrease the thickness of the electric drive 3. Higher efficiency of such electric drive 3 was proven by tests in comparison with the electric drives according to the known devices. Therefore, the present invention provides high efficient compact radial blower for cooling device that overcome problems associated with required space, increased sound level and decreased blower efficiency.

What is claimed is:

1. A high efficient compact radial blower comprising an impeller, an electric drive and a housing, wherein
(i) said impeller comprises an impeller disk with the first and second sides, radial blades protruded from said first side, a central hub mounting on an axle, and an inflow hub integrated with said impeller disk;
(ii) said inflow hub rigidly fixed with said central hub by at least 2 brackets, thus forms an impeller inlet;
(iii) said electric drive comprises a magnetized rotor located from said second side of said impeller disk and a stator with a central opening surrounded by circumferentially arrayed flat coil windings having magnetic axes parallel to said axle;
(iv) said magnetized rotor comprises spaced apart by an axial gap a flat ferromagnetic ring and a layer of magnetic means;
(v) said housing comprises a base supporting said axle, a shaped upper side with a blower inlet, and a side part with a blower outlet;
(vi) said shaped upper side at least partially surrounds said magnetized rotor;
(vii) at least one side of said stator at the outer is rigidly bounded with said shaped upper side while the inner part of said stator is placed at said axial gap;
(viii) said stator when is powered creates electromagnetic field providing a rotation of said impeller, thus ambient air flows through said blower inlet, said impeller inlet, said blades and said blower outlet in a series way.

2. The high efficient compact radial blower as claimed in claim 1, wherein said flat ring has teeth at the periphery.

3. The high efficient compact radial blower as claimed in claim 1, wherein said layer of magnetic means is integrated with said impeller disk while said flat ring is rigidly bounded with said inflow hub.

4. The high efficient compact radial blower as claimed in claim 3, wherein said layer of magnetic means comprises circumferentially arrayed permanent magnets having magnetic axes parallel to said axle and said permanent magnets are flush-mounted on the second side of said impeller disk.

5. The high efficient compact radial blower as claimed in claim 3, wherein said layer of magnetic means comprise peripheral teeth-shaped flat ring flush-mounted on the second side of said impeller disk and made from ferromagnetic material, and a permanent ring magnet with magnetic axis parallel to said axle placed coaxially on said peripheral teeth-shaped flat ring.

6. The high efficient compact radial blower as claimed in claim 1, wherein said flat ring is integrated with said impeller disk while said layer of magnetic means is rigidly bounded with said inflow hub.

7. The high efficient compact radial blower as claimed in claim 6, wherein said layer of magnetic means comprises circumferentially arrayed permanent magnets having magnetic axes parallel to said axle and fixed to a disk rigidly bounded with said inflow hub.

8. The high efficient compact radial blower as claimed in claim 1, wherein said stator made as a printed circuit board.

9. The high efficient compact radial blower as claimed in claim 1, wherein said side part has a spiral shape in the axial view, thus said side part together with said base and said shaped upper part form a spiral blower casing.

10. The high efficient compact radial blower as claimed in claim 1, wherein said side part comprises of at least three hollow standoffs rigidly connected with said base and said shaped upper side, thus the outer borders of said shaped upper side and said base together with said hollow standoffs form said blower outlet.

11. The high efficient compact radial blower as claimed in claim 10, wherein said base comprises clamping lugs located at the corners of said base and hollow standoffs comprises clamping claws, thus said clamping lugs and clamping claws provide together reliable junction between said base and said side part.

12. The high efficient compact radial blower as claimed in claim 9, wherein said base made of high heat conductive material further comprises pin-fin structure surrounded by said impeller, thus said radial blower serves as a heat-dissipating device.

13. The high efficient compact radial blower as claimed in claim 10, wherein said base made of high heat conductive material further comprises pin-fin structure surrounded by said impeller, thus said radial blower serves as a heat-dissipating device.

14. A high efficient compact radial blower comprising an impeller, an electric drive and a housing, wherein
(i) said impeller comprises an impeller disk with the first and second sides, radial blades protruded from said first side, and a central hub integrated with said impeller disk and mounting on an axle;
(ii) said electric drive comprises a magnetized rotor located from said second side of said impeller disk and a stator with a central opening surrounded by circumferentially arrayed flat coil windings having magnetic axes parallel to said axle;
(iii) said magnetized rotor comprises spaced apart by an axial gap a flat ferromagnetic ring and a layer of magnetic means;
(iv) said housing comprises a base supporting said axle, a shaped upper side with a blower inlet, and a side part with a blower outlet;
(v) said shaped upper side at least partially surrounds said magnetized rotor;
(vi) at least one side of said stator at the outer is rigidly bounded with said base while the inner part of said stator is placed at said axial gap;
(vii) said stator when is powered creates electromagnetic field providing a rotation of said impeller, thus ambient air flows through said blower inlet, said impeller inlet, said blades and said blower outlet in a series way.

15. The high efficient compact radial blower as claimed in claim 14, wherein said layer of magnetic means comprise circumferentially arrayed permanent magnets having magnetic axes parallel to said axle and said permanent magnets are flush-mounted in respect to the second side of said impeller disk.

16. The high efficient compact radial blower as claimed in claim 14, wherein said layer of magnetic means comprise a peripheral teeth-shaped flat ring flush-mounted in respect to the second side of said impeller disk and made from ferromagnetic material and a permanent ring magnet with magnetic axis parallel to said axle and placed at the central part of said peripheral teeth-shaped flat ring from the side opposite to said impeller disk.

17. The high efficient compact radial blower as claimed in claim 16, wherein said flat ferromagnetic ring has teeth at the periphery.

18. The high efficient compact radial blower as claimed in claim 14, wherein said flat ferromagnetic ring farther incorporated with circumferentially arrayed permanent magnets having magnetic axes parallel to said axle and spaced at the periphery of said flat ring.

19. The high efficient compact radial blower as claimed in claim 14, wherein said central hub has an axisymmetric profile in respect to said axle with a generatrix comprises of at least two opposite curved 90 degrees radiuses.
